(19) United States
(12) Patent Application Publication
(10) Pub. No.: US 2024/0221337 A1
(43) Pub. Date: Jul. 4, 2024

(54) 3D SPOTLIGHT

(71) Applicant: APPLE INC., Cupertino, CA (US)

(72) Inventors: Alexandre DA VEIGA, San Francisco, CA (US); Alexander MENZIES, Menlo Park, CA (US); Michael I. WEINSTEIN, San Francisco, CA (US); Vedant SARAN, Campbell, CA (US)

(21) Appl. No.: 18/603,533

(22) Filed: Mar. 13, 2024

Related U.S. Application Data
(63) Continuation of application No. PCT/US2022/043174, filed on Sep. 12, 2022.
(60) Provisional application No. 63/247,339, filed on Sep. 23, 2021.

(51) Int. Cl. G06T 19/20; G06F 3/01; G06T 17/20; G06V 10/22; G06V 10/46; G06V 20/64; H04S 7/00

(52) U.S. Cl. CPC G06T 19/20; G06F 3/011; G06T 17/20; G06V 10/22; G06V 10/462; G06V 20/64; H04S 7/303; G06T 2200/04; G06T 2210/56; G06T 2219/2004; H04S 2400/11

(57) ABSTRACT

Various implementations disclosed herein include devices, systems, and methods that provide 3D content that is presented over time (e.g. a video of 3D point-based frames), where the 3D content includes only content of interest, e.g., showing just one particular person, the floor near that person, and objects with which the person is near or interacting. The presented content may be stabilized within the viewers environment, for example, by removing content changes corresponding to movement of the capturing device.

### CROSS-REFERENCE TO RELATED APPLICATIONS

This patent application is a continuation of International Application No. PCT/US2022/043174 (International Publication No. WO 2023/048973) filed on Sep. 12, 2022, which claims priority of U.S. Provisional Application No. 63/247,339 filed on Sep. 23, 2021, entitled “3D SPOTLIGHT,” each of which is incorporated herein by this reference in its entirety.

### TECHNICAL FIELD

The present disclosure generally relates to electronic devices that capture, adjust, share, and/or present three-dimensional (3D) content such as 3D recordings, 3D broadcasts, and 3D communication sessions that include multiple frames of 3D content.

### BACKGROUND

Various techniques are used to generate 3D representations of physical environments. For example, a point cloud or 3D mesh may be generated to represent portions of a physical environment. Existing techniques may not adequately facilitate capturing, modifying, sharing, and/or presenting 3D recordings, 3D broadcasts, 3D communication sessions that include multiple frames of 3D content.

### SUMMARY

Various implementations disclosed herein include devices, systems, and methods that provide 3D content that is presented over time (e.g., a video of 3D point-based frames), where the 3D content includes only content of interest, e.g., showing just one particular person, the floor near that person, and objects with which the person is near or interacting. The presented content may be stabilized within the viewer's environment, for example, by adjusting 3D positions of the content to account for movement of the capturing device. Thus, for example, 3D content of a person dancing around can be presented in way that the viewer sees the dancer moving smoothly around within the viewer's environment without perceiving positional changes that might otherwise be presented due to movement of the capturing device. The 3D content may be floor aligned to further enhance the experience, e.g., making it seem as if the 3D content of the person dancing is dancing on the floor of the viewing environment. The 3D content may be true-life scale further enhancing the viewing experience. In alternative implementations, the 3D content is presented at a scale that differs from the scale of the viewing environment. For example, 3D content may be presented on a relatively small virtual stage, e.g., within a small holiday ornament. The 3D content may be presented with spatial audio based on identifying the source of a sound (e.g., the dancing person) and spatially positioning the sound so that the sound seems to come from the presented source. Initial placement of the 3D content (e.g., the first frame's content) may be based on the motion/path of the content of interest (e.g., the path the dancer moves through throughout the multiple frames) and/or the viewing environment in which the 3D content is played (e.g., in an area of open floor space in the viewing environment that is sufficiently large to accommodate the dancer's path).

In some implementations, a processor performs a method by executing instructions stored on a computer readable medium. The method selects content from a 3D content item that has multiple frames each having a 3D representation having elements (e.g., points of depth data, points of a 3D point cloud, nodes or polygons of a 3D mesh, etc.) representing a different respective time during a capturing of a capture environment. The selected content includes a subset of the elements of each of the multiple frames, e.g., just the elements corresponding to just one particular person, the floor near that person, and any objects with which the person is near or interacting. The selected content may exclude some of the captured elements, e.g., points corresponding to the background environment or that are otherwise not of interest. For example, the method may select just the elements of a dancer and the floor/objects within a vertical cylindrical region around the dancer in each frame. Selection of what elements to include may be based on object type (e.g., person), saliency, distance from an object of interest, and/or context, e.g., what the person is doing. For example, only content within a cylindrical bounding area around the dancer may be included and such a “spotlight” may move with the dancer, e.g., changing what content is included or not based on what is currently in the spotlight in each frame. The term “spotlight” is used to refer to a 3D region that changes position in the multiple frames to select content within it, where the 3D region changes position (and/or size) based on correspondence with an object or objects, e.g., following a dancer, a group of users, a moving object, etc. Non-salient features such as the ceiling may be excluded from selection even if within the spotlight.

The method may also determine positioning data for adjusting the positioning of the selected content in a viewing environment based on movement of a capturing device during the capturing of the multi-frame 3D content item. For example, the positioning data may be used to stabilize the 3D content within a viewing environment. In some implementations, the 3D content may be adjusted to remove content movement attributed to capturing device motion, e.g., so the dancer can be presented in a way such that the dancer appears to move in the viewing environment based only on their movement and not based on the movement of the camera that captured the dancer's dance.

The content selection and/or determination of positioning data may be performed by one or more different devices including a viewing device that provides a view of the select 3D content according to the positioning data, a capturing device that does the capturing of the 3D content, or another device separate from the viewing and capturing devices. Thus, in one example, a viewing device performs content selection, determination of positioning data, and presents the selected content based on the positioning data within the viewing environment. In another example, a capturing device performs content selection and determination of positioning data and provides the selected content and positioning data for presentation via a separate viewing device. In some implementations, a capturing device captures a 3D content item that is viewed at a later point in time using the capturing device and/or another device. In some implementations, a capturing device captures a 3D content item that is concurrently viewed by another device, e.g., a device in a different physical environment. In one example, two devices are involved in a communication session with one another and one of the devices shares a live 3D content item with the other device during the communication session. In another example, two devices are involved in a communication session with one another and each of the device's shares a live 3D content item with the other device, for example, enabling each of the receiving devices to view select content from the other device's environment, e.g., just a user of the other devices and objects that are near that other user.

A viewing device may provide a 3D view of select, frame-based 3D content, for example, by providing that 3D content within an extended reality (XR) environment. For example, a head-mounted device (HMD) may provide stereoscopic views of an XR environment that includes the select, frame-based 3D content and/or provide views of the XR environment based on the viewer's position, e.g., enabling the viewer to move around to view the select 3D content within the XR environment to view the select 3D content from different viewing perspectives. Viewing select, frame-based 3D content in stereo and/or based on the viewer's viewpoint may provide an immersive or otherwise desirable way to experience captured or streamed 3D content items. A parent may be enabled to experience a recording or live-stream of their child's first steps within an immersive and otherwise desirable way, e.g., experiencing a 3D experience of the child first steps years later or from a live remote location as if the child were walking around the parent's current environment.

In some implementations, the viewing of select, frame-based 3D content is facilitated by a capturing device capturing image data, depth data, and motion data, from which the viewing of select 3D content can be provided by a viewing device within a viewing environment. Such data may be captured by image, depth, and motion sensors that are available on many existing mobile, tablet, and imaging devices. Accordingly, implementations disclosed herein can provide 3D content experiences that do not require specialized capture equipment. In some implementations, such devices may capture content via a specialized capture mode configured to concurrently capture and store image, depth, and motion data as a 3D content item (e.g., as a single file, set of files, or data stream) from which 3D content may be selected and positioning data determined to enable later (or live-stream) viewing of select, frame-based 3D content.

In some implementations, an existing 2D video is processed to generate select, frame-based 3D content that can be viewed within an XR environment. For example, the frames of a 2D video may be evaluated via algorithms or machine learning models to assign depth data to objects depicted in the frames and to determine interframe camera movements. The resulting 2D images, depth data, and motion data can then be used to provide select frame-based 3D content according to techniques disclosed herein. For example, an 2D video (e.g., image data only) of a 1980's dance recital could be processed to identify depth data (e.g., 3D points) of one of the dancers and motion data of the camera, which may enable presenting 3D content of just the dancer within an XR experience, e.g., enabling a viewer in 2021 to view a 3D depiction of the dancer dancing within the viewer's current living room.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an exemplary electronic device operating in a physical environment in accordance with some implementations.

FIG. 2 illustrates a depiction of the electronic device of FIG. 1 capturing a 3D content item having multiple frames in accordance with some implementations.

FIG. 3 illustrates depictions of aspects of the 3D content item captured by the electronic device of FIG. 2 in accordance with some implementations.

FIG. 4 illustrates selecting content from the 3D content item captured by the electronic device of FIG. 2 in accordance with some implementations.

FIG. 5 illustrates an exemplary electronic device operating in a physical environment in accordance with some implementations.

FIG. 6 illustrates an XR environment provided by the electronic device of FIG. 5 based on the 3D content item captured by the electronic device of FIGS. 1-3 in accordance with some implementations.

FIG. 7 is a flowchart illustrating a method for selecting and stabilizing 3D content from a frame-based 3D content item, in accordance with some implementations.

FIG. 8 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

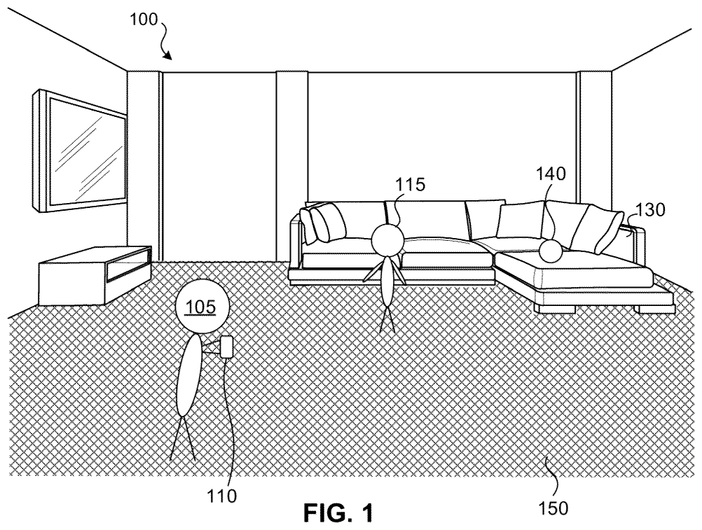

FIG. 1 illustrates an exemplary electronic device 110 operating in a physical environment 100. The electronic device 110 may be (but is not necessarily) involved in a broadcast, streaming, or other communication session, e.g., the electronic device 110 may live stream 3D content to one or more other electronic devices (not shown). In this example of FIG. 1, the physical environment 100 is a room that includes a floor 150, a couch 130, another person 115, and a ball 140, among other things. The electronic device 110 includes one or more cameras, microphones, depth sensors, motion sensors, or other sensors that can be used to capture information about and evaluate the physical environment 100 and the objects within it, as well as information about the user 110 of the electronic device 110. The information about the physical environment 100 and/or user 110 may be used to provide visual and audio content, for example, providing a 3D content item having multiple frames of 3D content in a stored recording file or package or stream during a live-streaming session.

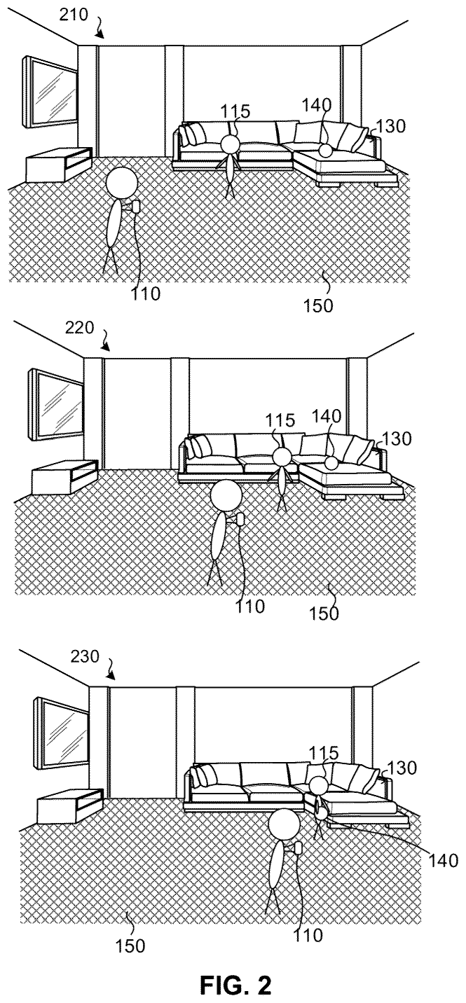

FIG. 2 illustrates a depiction of the device 110 of FIG. 1 capturing a 3D content item having multiple frames in accordance with some implementations. In this example, at a first instant in time 210 a first frame of a 3D content item is captured by the device 110 while the device 110 is at a first position and the person 115 is at a position near the left side of the couch 130. At a second instant in time 220, a second frame of the 3D content item is captured by the device 110 after the device 110 has moved to the right within the capturing environment. The person 115 has also moved to the right within the capturing environment. At a third instant in time 230, a third frame of the 3D content item is captured by the device 110 after the device 110 has moved further to the right than at the second instant in time 220 within the capturing environment. The person 115 has also moved further to the right and picked up and is holding the ball 140. FIG. 2 illustrates capturing multiple frames of a 3D content item by an electronic device using three frames. Captured content items may include fewer or more frames and may include frames that are more (or less) similar to adjacent frames than those illustrated in FIG. 2, e.g., capturing 60 frames per second may result in adjacent frames in which captured content moves only slightly from frame to frame due to the relatively high capture rate relative to the speeds of movement of objects in the environment.

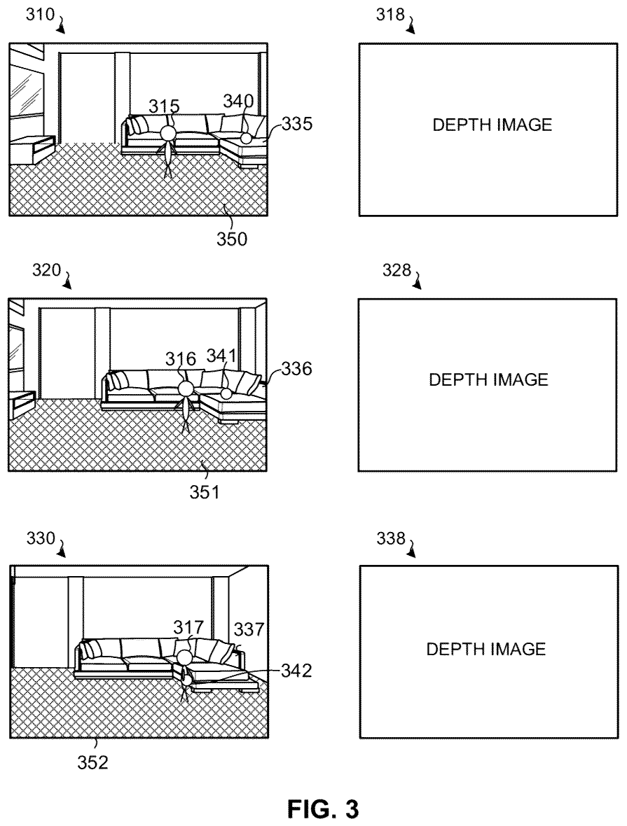

FIG. 3 illustrates depictions of aspects of the 3D content item captured by the device of FIG. 2 in accordance with some implementations. In this example, the first frame (captured at the first instant in time 210) includes a camera image 310 (e.g., an RGB image) and a depth image 318. The camera image 310 includes pixels depicting the appearance of objects including a depiction 315 of the person 115, a depiction 335 of the couch 130, a depiction 340 of the ball 140, and a depiction 350 of the floor 150. The depth image 318 may include depth values that correspond to one or more of the pixels of the camera image 310, for example, identifying the distance of a pixel corresponding to a pixel on the ball depiction 340, the distance corresponding to the distance between the camera and that portion of the ball 140 at the first instant in time 210. In addition, motion data associated with the device 110 at the first instant in time 210 may be tracked and/or collected as part of data collected about the first frame at the first instant in time 210. Such motion data may identify movement of the device 110 with respect to a prior point in time, e.g., a prior time, and/or a starting position or point in time.

Similarly, the second frame (captured at the second instant in time 220) includes a camera image 320 (e.g., an RGB image) and a depth image 328. The camera image 320 includes pixels depicting the appearance of objects including a depiction 316 of the person 115, a depiction 336 of the couch 130, a depiction 341 of the ball 140, and a depiction 351 of the floor 150. The depth image 328 may include depth values that correspond to one or more of the pixels of the camera image 320, for example, identifying the distance of a pixel corresponding to a pixel on the ball depiction 341, the distance corresponding to the distance between the camera and that portion of the ball 140 at the second instant in time 220. In addition, motion data associated with the device 110 at the second instant in time 220 may be tracked and/or collected as part of data collected about the second frame at the second instant in time 220. Such motion data may identify movement of the device 110 with respect to a prior point in time, e.g., since the first instant in time 210 and/or a starting position or point in time.

Similarly, the third frame (captured at the third instant in time 230) includes a camera image 330 (e.g., an RGB image) and a depth image 338. The camera image 330 includes pixels depicting the appearance of objects including a depiction 317 of the person 115, a depiction 337 of the couch 130, a depiction 342 of the ball 140, and a depiction 352 of the floor 150. The depth image 338 may include depth values that correspond to one or more of the pixels of the camera image 330, for example, identifying the distance of a pixel corresponding to a pixel on the ball depiction 342, the distance corresponding to the distance between the camera and that portion of the ball 140 at the third instant in time 230. In addition, motion data associated with the device 110 at the third instant in time 230 may be tracked and/or collected as part of data collected about the third frame at the third instant in time 230. Such motion data may identify movement of the device 110 with respect to a prior point in time, e.g., since the second instant in time 220 and/or a starting position or point in time.

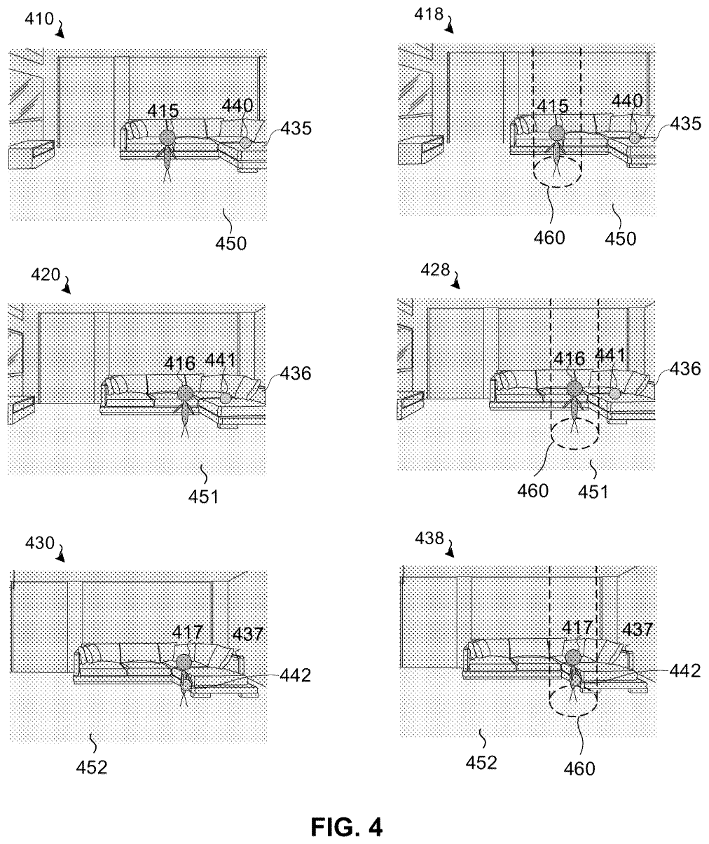

FIG. 4 illustrates point data corresponding to the frames of the 3D content item captured at the instants in time depicted in FIGS. 2 and 3. The data about each frame of the 3D content item (e.g., camera images 310, 320, 330, depth images 318, 328, 338, motion data, etc.) may be used in generating a 3D representation (e.g., a point cloud, mesh, or the like) corresponding to each frame. For example, the depth data may be used to determine 3D positions of points or polygons that are given colors/textures based on the image data. The relative positions between points or polygons in the multiple frames can be associated based on the camera motion data.

In this example, point cloud 410 corresponds to the frame associated with the first instant in time 210, point cloud 420 corresponds to the frame associated with the second instant in time 220, and the point cloud 430 corresponds to the frame associated with the third instant in time 230. Point cloud 410 includes points corresponding to the 3D positions on surfaces in the captured environment at the first point in time 210, e.g., points 415 correspond to points on surfaces of the person 115, points on 435 correspond to points on surfaces of the couch 130, points 440 correspond to points on surfaces of the ball 140, and points 450 correspond to points on the surface of the floor 150. Point cloud 420 includes points corresponding to the 3D positions on surfaces in the captured environment at the second point in time 220, e.g., points 416 correspond to points on surfaces of the person 115, points on 436 correspond to points on surfaces of the couch 130, points 441 correspond to points on surfaces of the ball 140, and points 451 correspond to points on the surface of the floor 150. Point cloud 430 includes points corresponding to the 3D positions on surfaces in the captured environment at the third point in time 230, e.g., points 417 correspond to points on surfaces of the person 115, points on 437 correspond to points on surfaces of the couch 130, points 442 correspond to points on surfaces of the ball 140, and points 452 correspond to points on the surface of the floor 150. Each of these point clouds 410, 420, 430 may be associated with (e.g., defined according to) its own coordinate system. Accordingly, because of the different image capture positions of the device 110 at the first, second, and third points in time 210, 220, 230, the point clouds 410, 420, 430 may not be aligned with one another or otherwise be associated with or defined in terms of a common coordinate system. As described herein, however, alignment to a common coordinate system may be achieved based on motion data and/or based assessing capture device movement based on image, depth, or other sensor data.

FIG. 4 further illustrates selecting content from the 3D content item. In this example, as illustrated in depictions 418, 428, and 438, points in a selected region 460 of each point cloud 410, 420, 430 are selected. In depiction 418, only points 415 and a subset of the points 450 within the region 460 are selected. In depiction 428, only points 416 and a subset of the points 451 within the region 460 are selected. In depiction 438, only points 417, a subset of the points 452 within the region 460, and points 442 (corresponding to ball 140) are selected. In this example, the region 460 is determined based on detecting an object within the content item having a particular characteristic (e.g., object type=person) and the region 460 is centered around that person. In this example, characteristics of the region 460 (e.g., size, shape, etc.) are selected and used in using the region 460 to select a subset of less than all of the points of the point clouds 410, 420, 430. The characteristics of the region 460 may be preset and/or determined based on the 3D content item, e.g., a content item depicting a group of 5 people may have a larger size and/or a different shape than a content item depicting only a single person. In this example, the selected content is centered around an identified person 115 who moves during the capturing of the 3D content item. In other implementations, the selection of content can be performed differently, e.g., based on detecting activity, detecting movement, user selection, user preferences, etc.

Motion data associated with the 3D content item may be used to correlate (e.g., stabilize) the points selected from the 3D content item. The 3D content may be stabilized to provide an improved viewing experience. For example, this may involve adjusting 3D positions of the content (e.g., associating them with a common coordinate system) to account for movement of the capturing device based on the motion data. Thus, for example, 3D content of the person 115 moving can be stabilized in way that a viewer will see depictions of the person 115 based on the selected points moving smoothly within the viewer's environment without perceiving positional changes that would otherwise be presented due to movement of the capturing device 110. In other words, the movement that the viewer sees would correspond to movement of the person 115 without being influenced by the movement of the device 110 during the capturing of the 3D content item.

In the example of FIG. 4, the points of the 3D content item frames are points of 3D point clouds. Other types of 3D points may be used in alternative implementations. For example, the points may simply correspond to depth data points to which texture/color has been assigned based on captured camera image data. In another example, the points may correspond to points of a 3D mesh (e.g., vertices) and camera image data may be used to define the appearance of shapes (e.g., triangles) formed by the points of the 3D mesh. Note that actual 3D content item frame content (e.g., textured depth points, 3D point clouds, 3D meshes, etc.) may have more variable, less consistently spaced point locations, more or fewer points or otherwise differ from the depictions, which are provided as functional illustrations rather than spatially-accurate portrayals of actual points. Points of a 3D representation, for example, may correspond to depth values measured by a depth sensor and thus may be more sparse for objects farther from the sensor than for objects closer to the sensor. Each of the points of the 3D representation may correspond to a location in 3D a coordinate system and may have a characteristic (e.g., texture, color, greyscale, etc.) indicative of an appearance of a corresponding portion of the physical environment. In some implementations, an initial 3D representation is generated based on sensor data and then an improvement process is performed to improve the 3D representation, e.g., by filling holes, performing densification to add points to make the representation denser, etc.

In some implementations, sound is associated with one or more of the 3D content item frames. Such sound may include spatial audio. For example, a microphone array may be used to obtain multiple individual concurrent sound signals which together can be interpreted by an algorithm or machine learning model to generate a spatial signal. In addition, computer vision techniques, such as depth-based computations and salient feature detection, may be used to estimate which parts of the scene emitted audio in order to localize detected sounds to those positions. Accordingly, recorded sound content may be associated with 3D sound source locations that can be used to provide spatialized audio corresponding to the 3D content item frames during playback.

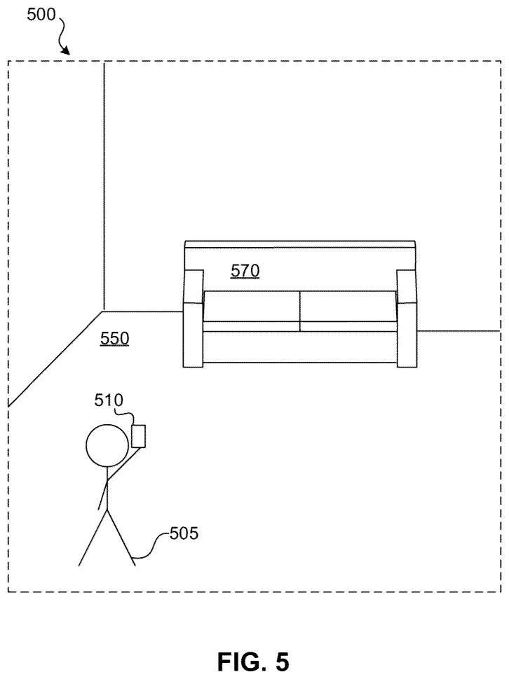

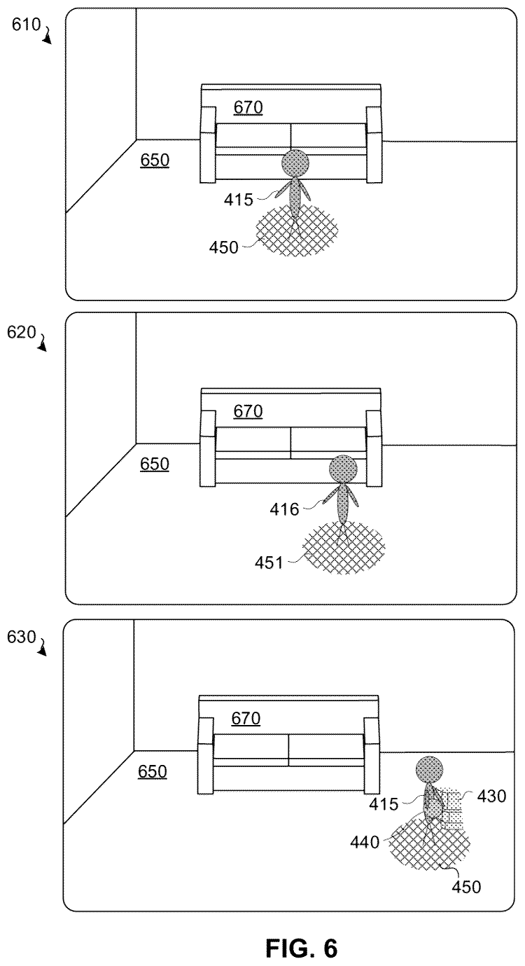

FIGS. 5 and 6 illustrate providing a view of the 3D content item captured during the first, second, and third instants of time depicted in FIG. 2. The selected content of the 3D content item is presented within a viewing environment. FIG. 5 illustrates an exemplary electronic device 510 operating in a physical environment 500. In this example, the physical environment 500 is different than physical environment 100 depicted in FIG. 1 and the viewer 505 is different that the user 105 that captured the 3D content item. However, in some implementations a 3D content item may be viewed in the same physical environment that it was captured in and/or by the same user and/or device that captured the 3D content item. In such implementations, the position of selected content from the 3D content item may be displayed based on the positioning of the corresponding objects during capture, e.g., a depiction of the person 115 may be presented to appear to be walking in the exact same path, etc. In the example of FIG. 5, the physical environment includes a sofa 570 and a floor 550.

FIG. 6 illustrates an XR environment provided by the electronic device 510 of FIG. 5 based on the 3D content item captured by the electronic device 110 of FIGS. 1-3. In this example, the view includes three exemplary frames 610, 620, 630 corresponding to the three frames of the 3D content items corresponding to the captured instants in time 210, 220, 230. Each of these three frames 610, 620, 630 includes depictions of portions of the physical environment 500 of FIG. 5, e.g., depiction 670 of sofa 570 and depiction 650 of floor 550. The first frame 610 also includes depictions based on the selected content (e.g., subset of points) for the first instant in time 210, e.g., it includes depictions based on the points 415 corresponding the person 115 and some of the points 450 corresponding to some of the floor 150 that was within the region 460. Similarly, the second frame 620 also includes depictions based on the selected points for the second instant in time 220, e.g., it includes depiction based on the points 416 corresponding the person 115 and some of the points 451 corresponding to some of the floor 150 that was within the region 460. Similarly, the third frame 630 also includes depictions based on the selected points for the third instant in time 230, e.g., it includes depictions based on the points 417 corresponding the person 115, points 452, 430, 440 corresponding to some of the floor 150, some of the sofa 130, and the ball 140 that were within the region 460 at the third instant in time 230. In some implementation, the depictions include the points, while in other implementations the depictions are generated based on the points, e.g., by adding more points, filling holes, smoothing, and/or generating or modifying a 3D representation such as a mesh using the points.

In the example of FIGS. 5-6, the 3D content item is stabilized so that the 3D content of the 3D content item moves according to its movements in physical environment 100 during the capturing but does not move based on movement of the capturing device (e.g., device 110) during the capturing of the 3D content item. Such stabilization may be based on motion data captured during the capturing of the 3D content item and/or based on analysis of the image, depth, etc. of the frames of the 3D content item. For example, two consecutive frames of a 3D content item may be input to a computer vision algorithm or machine learning model that estimates capture device motion based on detecting differences in the consecutive frames. In some implementations, each frame of a 3D content item is associated with a coordinate system and motion data obtained during capturing and/or based on analysis of image/depth data is used to identify transforms or other relationships between coordinate systems that enables the 3D content items to be stabilized such that the 3D content of the 3D content item moves according to its movements in physical environment during the capturing but does not move based on movement of the capturing device during the capturing of the electronic content item.

The frames of content may be played back within an XR environment at the same rate at which the frames were captured, e.g., occurred in real time, or at a differing rate. In one example, a slow-motion playback of the frames is provided by increasing the relative time that each frame is displayed (e.g., by displaying each frame twice in a row) or by increasing the transition time between frames. In another example, fast-motion playback of the frames is provided by decreasing the relative time that each frame is displayed, excluding some frames from playback (e.g., only using every other frame), or by decreasing the transition time between frames.

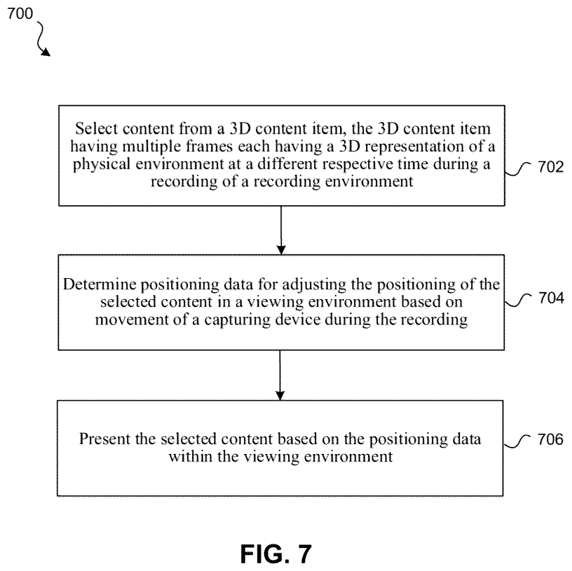

FIG. 7 is a flowchart illustrating a method for selecting and stabilizing 3D content from a frame-based 3D content item. In some implementations, a device such as electronic device 110, electronic device 510, or a combination of devices performs the steps of the method 700. In some implementations, method 700 is performed on a mobile device, desktop, laptop, HMD, ear-mounted device or server device. The method 700 is performed by processing logic, including hardware, firmware, software, or a combination thereof. In some implementations, the method 700 is performed on a processor executing code stored in a non-transitory computer-readable medium (e.g., a memory).

At block 702, the method 700 selects content from a 3D content item, the 3D content item having multiple frames each having a 3D representation having points representing a different respective time during a capturing of a capture environment. The selected content includes a subset of the points of each of the multiple frames. For example, this may involve selecting just the points of a particular person or group of persons or of a particular object or group of objects. This may involve selecting persons or objects based on characteristics of the persons and/or objects. This may involve selecting persons and/or objects based on a saliency test and/or using a saliency map that identifies the saliency of different objects with respect to criteria, e.g., objects related to people, object related to a moving object, objects related to a particular topic, etc.

The selecting may involve selecting content based on identifying a person or object of interest and then identifying content within a nearby or surrounding region. In one example, the selecting selects all content (e.g., floor, ceiling, walls, furniture, other objects, etc.) within a volumetric (e.g., cylindrical or cuboid) region around an identified person(s) or object(s) of interest. In some implementations, the selection of what content (e.g., points) to include may be based on context, e.g., what a person of interest is doing, the time of day, a type of environment (e.g., stage, living room, class room, nursery, etc.).

In one example, only content within a cylindrical bounding area having a predetermined or dynamically determined radius around person(s) or object(s) of interest may be included. Such a selection region may be a “spotlight” that moves with the person(s) or object(s) of interest in each frame, e.g., changing what content is included or not based on what is currently in the spotlight in each frame.

In some implementations, features such as the ceiling may be excluded based on exclusion criteria (e.g., type, size, shape, lack of movement or movability, etc.) even if within such a spotlight.

In some implementations, selection of content involves cropping out occluding content and/or generating new content for an occluded portion of content. For example, image and depth data associated with a particular frame of 3D content may depict a person where a chair in front of the camera occludes a portion of the person's arm. This chair may be excluded from the selected content and content corresponding to the missing portion of the person's arm may be generated, e.g., using the current frame's and/or one or more other frame's data.

In some implementations, selection of content is based on input from a user, e.g., during capture of the 3D content item or at a later time while reviewing the 3D content item. For example, a capturing user may provide input (e.g., verbal, gesture, input device-based, etc.) identifying particular objects or types of objects. In another example, a user reviews one or more frames and selects content of interest and manually provides input (e.g., verbal, gesture, input device-based, etc.) identifying particular objects or types of objects. Input provided in one frame may be used to identify content in multiple frames, e.g., selecting a particular person in one frame may be used to select that person in multiple frames.

In some implementations, during a capturing event, e.g., during which a user captures sensor data used to provide frames of a 3D content item, guidance is provided to a user to facilitate capturing data sufficient to provide a high or best quality 3D experience, e.g., “get closer to the subject,” “center the subject in the camera view,” “lower the capturing device,” “make lights brighter,” etc.

In some implementations, selection of content involves separating out foreground content from background content and including some or all of the foreground content and excluding some or all of the background content.

The method 700 may involve selecting audio and/or defining spatialized audio based on the selection of the content from the 3D content item. For example, this may involve identifying an object in the 3D content, identifying that the object is a source of a sound, and spatially positioning the sound based on a position of the object in the 3D content.

At block 704, the method 700 determines positioning data for adjusting the positioning of the selected content in a viewing environment based on movement of a capturing device during the capturing of the multi-frame 3D content item. The positioning data may be used to stabilize the 3D content within a viewing environment as illustrated in FIGS. 5 and 6. For example, the content may be adjusted to account for capturing device motion, e.g., so the depiction of a person appears to move in the viewing environment based only on their movement and not on movement of the capturing device. The positioning data may be configured to stabilize the 3D content within a viewing environment by reducing apparent motion of the 3D content due to motion during the capturing of the 3D content item.

The content selection and/or determination of positioning data may be performed by one or more different devices including a viewing device that provides a view of the select 3D content according to the positioning data, a capturing device that does the capturing of the 3D content, or another device separate from the viewing and capturing devices. Thus, in one example, a viewing device performs content selection, determination of positioning data, and presents the selected content based on the positioning data within the viewing environment. In another example, a capturing device performs content selection and determination of positioning data and provides the selected content and positioning data for presentation via a separate viewing device. In some implementations, a capturing device captures a 3D content item that is viewed at a later point in time using the capturing device and/or another device. In some implementations, a capturing device captures a 3D content item that is concurrently viewed by another device, e.g., a device in a different physical environment. In one example, two devices are involved in a communication session with one another and one of the devices shares a live 3D content item with the other device during the communication session. In another example, two devices are involved in a communication session with one another and each of the devices shares a live 3D content item with the other device, for example, enabling each of the receiving devices to view select content from the other device's environment, e.g., just a user of the other device and objects that are near that other user.

At block 706, a viewing device may provide a 3D view of select, frame-based 3D content, for example, by providing that 3D content within an extended reality (XR) environment. For example, a head-mounted device (HMD) may provide stereoscopic views of an XR environment that includes the select, frame-based 3D content and/or provide views of the XR environment based on the viewer's position, e.g., enabling the viewer to move around to view the select 3D content within the XR environment to view the select 3D content from different viewing perspectives. Viewing select, frame-based 3D content in stereo and/or based on the viewer's viewpoint may provide an immersive or otherwise desirable way to experience captured or streamed 3D content items. A parent may be enabled to experience a recording or live-stream of their child's first steps within an immersive and otherwise desirable way, e.g., experiencing a 3D experience of the child first steps years later or from a live remote location as if the child were walking around the parent's current environment.

In some implementations, the viewing of select, frame-based 3D content is facilitated by a capturing device capturing image data, depth data, and motion data, from which the viewing of select 3D content can be provided by a viewing device within a viewing environment. Such data may be captured by image, depth, and motion sensors that are available in many existing mobile, tablet, and imaging devices. Accordingly, implementations disclosed herein can provide 3D content experiences that do not require specialized capture equipment. In some implementations, such devices may capture content via a specialized capture mode configured to concurrently capture and store image, depth, and motion data from which 3D content may be selected and positioning data determined to enable later (or live-stream) viewing of select, frame-based 3D content.

In some implementations, an existing 2D video is processed to generate select, frame-based 3D content that can be viewed within an XR environment. For example, the frames of a 2D video may be evaluated via algorithms or machine learning models to assign depth data to objects of interest and to determine interframe camera movements. The resulting 2D images, depth data, and motion data can then be used to provide select frame-based 3D content. For example, an 2D video (e.g., image data only) of a 1980's dance recital could be processed to identify depth data (e.g., 3D points) of one of the dancers and motion data of the camera, which may enable presenting 3D content of just the dancer within an XR experience, e.g., enabling a viewer in 2021 to view the dancer in 3D dancing within their current living room.

A viewing device may position frame-based content for a 3D content item based on various criteria. In some implementations, a view device identifies initial placement (e.g., for select content from a first frame) based on a path of the selected content during the course of multiple frames. For example, such content may be positioned to avoid apparent collisions with walls or other depictions of content from the viewing environment. In some implementations, the method 700 further involves determining a position for presenting the 3D content item within a viewing environment based on movement of the selected content during the capturing, available space within the viewing environment, or a pose of a viewer (e.g., a user or user's device) in the viewing environment. In some implementations, the viewing device may align a ground plane of the 3D content item with a ground plane of a viewing environment.

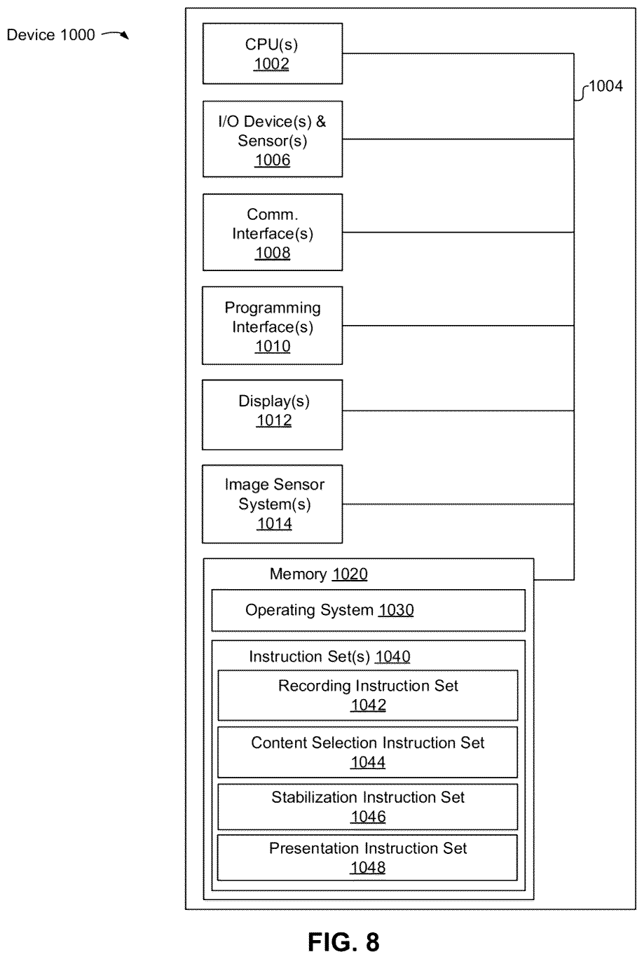

FIG. 8 is a block diagram of electronic device 1000. Device 1000 illustrates an exemplary device configuration for electronic device 110 or electronic device 510. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1000 includes one or more processing units 1002 (e.g., microprocessors, ASICs, FPGAs, GPUs, CPUs, processing cores, and/or the like), one or more input/output (I/O) devices and sensors 1006, one or more communication interfaces 1008 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 1010, one or more output device(s) 1012, one or more interior and/or exterior facing image sensor systems 1014, a memory 1020, and one or more communication buses 1004 for interconnecting these and various other components.

In some implementations, the one or more communication buses 1004 include circuitry that interconnects and controls communications between system components. In some implementations, the one or more I/O devices and sensors 1006 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1012 include one or more displays configured to present a view of a 3D environment to the user. In some implementations, the one or more displays 1012 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1000 includes a single display. In another example, the device 1000 includes a display for each eye of the user.

In some implementations, the one or more output device(s) 1012 include one or more audio producing devices. In some implementations, the one or more output device(s) 1012 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1012 may additionally or alternatively be configured to generate haptics.

In some implementations, the one or more image sensor systems 1014 are configured to obtain image data that corresponds to at least a portion of a physical environment. For example, the one or more image sensor systems 1014 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1014 further include illumination sources that emit light, such as a flash. In various implementations, the one or more image sensor systems 1014 further include an on-camera image signal processor (ISP) configured to execute a plurality of processing operations on the image data.

The memory 1020 includes high-speed random-access memory, such as DRAM, SRAM, DDR RAM, or other random-access solid-state memory devices. In some implementations, the memory 1020 includes non-volatile memory, such as one or more magnetic disk storage devices, optical disk storage devices, flash memory devices, or other non-volatile solid-state storage devices. The memory 1020 optionally includes one or more storage devices remotely located from the one or more processing units 1002. The memory 1020 comprises a non-transitory computer readable storage medium.

In some implementations, the memory 1020 or the non-transitory computer readable storage medium of the memory 1020 stores an optional operating system 1030 and one or more instruction set(s) 1040. The operating system 1030 includes procedures for handling various basic system services and for performing hardware dependent tasks. In some implementations, the instruction set(s) 1040 include executable software defined by binary information stored in the form of electrical charge. In some implementations, the instruction set(s) 1040 are software that is executable by the one or more processing units 1002 to carry out one or more of the techniques described herein.

The instruction set(s) 1040 include recording instruction set 1042 configured to, upon execution, generate sensor data corresponding to capturing a 3D content item including camera images, depth data, audio data, motion data, and/or other sensor data, as described herein. The instruction set(s) 1040 further include content selection instruction set 1044 configured to, upon execution, select content from a 3D content item as described herein. The instruction set(s) 1040 further include stabilization instruction set 1046 configured to, upon execution, determine positioning data for adjusting the positioning of the selected content in a viewing environment based on movement of a capturing device during the capturing of the multi-frame 3D content item, as described herein. The instruction set(s) 1040 further include presentation instruction set 1048 configured to, upon execution, present select content from a 3D content item, for example, based on positioning data, as described herein. The instruction set(s) 1040 may be embodied as a single software executable or multiple software executables.

Although the instruction set(s) 1040 are shown as residing on a single device, it should be understood that in other implementations, any combination of the elements may be located in separate computing devices. Moreover, FIG. 10 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The described technology may gather and use information from various sources. This information may, in some instances, include personal information that identifies or may be used to locate or contact a specific individual. This personal information may include demographic data, location data, telephone numbers, email addresses, date of birth, social media account names, work or home addresses, data or records associated with a user's health or fitness level, or other personal or identifying information.

The collection, storage, transfer, disclosure, analysis, or other use of personal information should comply with well-established privacy policies or practices. Privacy policies and practices that are generally recognized as meeting or exceeding industry or governmental requirements should be implemented and used. Personal information should be collected for legitimate and reasonable uses and not shared or sold outside of those uses. The collection or sharing of information should occur after receipt of the user's informed consent.

It is contemplated that, in some instances, users may selectively prevent the use of, or access to, personal information. Hardware or software features may be provided to prevent or block access to personal information. Personal information should be handled to reduce the risk of unintentional or unauthorized access or use. Risk can be reduced by limiting the collection of data and deleting the data once it is no longer needed. When applicable, data de-identification may be used to protect a user's privacy.

Although the described technology may broadly include the use of personal information, it may be implemented without accessing such personal information. In other words, the present technology may not be rendered inoperable due to the lack of some or all of such personal information.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a processor of a device:
selecting content from a three-dimensional (3D) content item, the 3D content item comprising multiple frames each comprising a 3D representation having elements and representing a different respective time during a capturing of a capture environment, the selected content comprising a subset of the elements of each of the multiple frames; and
determining positioning data for adjusting a positioning of the selected content in a viewing environment based on movement of a capturing device during the capturing of the 3D content item.

2. The method of claim 1 further comprising presenting the selected content based on the positioning data within the viewing environment.

3. The method of claim 2, wherein presenting the selected content comprises:
aligning a floor portion of the selected content with a floor of the viewing environment.

4. The method of claim 2, wherein presenting the selected content comprises presenting the selected content in life size or at a reduced size in the viewing environment.

5. The method of claim 1 further comprising:
generating the 3D content item based on image, depth, and motion data obtained via sensors of the device; and
providing the selected content and positioning data for presentation via a second device separate from the device.

6. The method of claim 1 further comprising providing the selected content and positioning data for presentation via a second device separate from the device.

7. The method of claim 1, wherein the content is selected based on identifying an object in the 3D content item and a type of the object.

8. The method of claim 1, wherein the content is selected based on generating a saliency map.

9. The method of claim 1, wherein the content is selected for each of the frames based on:
identifying an object; and
identifying additional content within a region around the object, the region having a defined shape and size.

10. The method of claim 9, wherein the region is a vertical cylinder encompassing a volume around the object.

11. The method of claim 9, wherein the region is repositioned in each of the frames based on the object.

12. The method of claim 9, wherein the content is selected based on excluding a non-salient feature within the region.

13. The method of claim 1, wherein the content is selected based on identifying a context in the 3D content item.

14. The method of claim 1, wherein the positioning data is configured to stabilize the 3D content within a viewing environment by reducing apparent motion of the 3D content due to motion during the capturing of the 3D content item.

15. The method of claim 1 further comprising:
identifying an object in the 3D content;
identifying that the object is a source of a sound; and
spatially positioning the sound based on a position of the object in the 3D content.

16. The method of claim 1 further comprising determining a position for presenting the 3D content item within a viewing environment based on:
movement of the selected content during the capturing;
available space within the viewing environment; or
a pose of a viewer in the viewing environment.

17. The method of claim 1, wherein the 3D representation comprises a 3D point cloud and the elements comprise points of the 3D point cloud.

18. The method of claim 1, wherein the 3D representation comprises a 3D mesh and the elements comprise nodes or polygons of the 3D mesh.

19. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
selecting content from a three-dimensional (3D) content item, the 3D content item comprising multiple frames each comprising a 3D representation having elements and representing a different respective time during a capturing of a capture environment, the selected content comprising a subset of the elements of each of the multiple frames; and
determining positioning data for adjusting a positioning of the selected content in a viewing environment based on movement of a capturing device during the capturing of the 3D content item.

20. The device of claim 19, wherein the operations further comprise presenting the selected content based on the positioning data within the viewing environment.

21. The device of claim 20, wherein presenting content comprises:
aligning a floor portion of the selected content with a floor of the viewing environment.

22. A non-transitory computer-readable storage medium storing program instructions executable via one or more processors to perform operations comprising:
selecting content from a three-dimensional (3D) content item, the 3D content item comprising multiple frames each comprising a 3D representation having elements and representing a different respective time during a capturing of a capture environment, the selected content comprising a subset of the elements of each of the multiple frames; and
determining positioning data for adjusting a positioning of the selected content in a viewing environment based on movement of a capturing device during the capturing of the 3D content item.
